(19) United States
(12) Patent Application Publication
(10) Pub. No.: US 2013/0092146 A1
(43) Pub. Date: Apr. 18, 2013

(54) CHIMNEY STARTER

(71) Applicants: Michael J. Grob, Cottage Grove, WI (US); James C. Gariti, Cottage Grove, WI (US)

(72) Inventors: Michael J. Grob, Cottage Grove, WI (US); James C. Gariti, Cottage Grove, WI (US)

(73) Assignee: James C. Gariti, Cottage Grove, WI (US)

(21) Appl. No.: 13/273,754

(22) Filed: Oct. 14, 2011

(51) Int. Cl. F23Q 13/02; A47J 37/07

(52) U.S. Cl. 126/25 B

(57) ABSTRACT

A device is provided that includes a rectangular strip of metal joined on opposing ends to form a wall of a hollow, open-ended cylinder having a length of less than eighteen inches and a diameter less than twelve inches, a metal baffle disposed within the cylinder proximate a first end of the cylinder in a spaced apart relationship with the first end, a coupler defining a passageway extending through the wall of the cylinder proximate the metal baffle and on a side of the baffle opposite the first end and a blower connected to the coupler that blows air through the coupler into the cylinder.

### FIELD OF THE INVENTION

The field of the invention relates to charcoal fires used for cooking in outdoor grills and more particularly to methods of starting charcoal fires.

### BACKGROUND OF THE INVENTION

Charcoal fires used for cooking on outdoor grills are known. For many people, charcoal is the preferred fuel for outdoor cooking because of the intense, even heat provided by charcoal over a relatively small area.

While charcoal is a convenient source of heat for cooking, it is often difficult to ignite. In most cases, charcoal is received in the form of compressed briquettes from any of a number of commercial sources (e.g., Kingsford). However, the compressed composition of the briquettes reduces the surface area and makes the briquettes hard to ignite.

One solution had been to douse the briquettes with a lighter fluid made from a petroleum based accelerant. However, the use of an accelerant may affect the taste of food cooked on such fires. In addition, the use of accelerants contributes to air pollution by evaporation and also due to combustion by-products cause by burning of the accelerants.

Another solution has involved the use of chimney starters. A chimney starter uses a tube with an internal baffle to support the charcoal and space beneath the baffle for a wad of newspaper. Once the newspaper is lit, holes around the base of the chimney allow the burning newspaper to ignite the charcoal. While such devices are effective, the process is slow and generates a great deal of smoke. Accordingly, a need exists for better devices for igniting charcoal.

### SUMMARY

Under one illustrated embodiment a device is provided that includes a rectangular strip of metal joined on opposing ends to form a wall of a hollow, open-ended cylinder that receives charcoal during ignition of the charcoal, the open-ended cylinder having a length of less than eighteen inches and a diameter less than twelve inches, a metal baffle disposed beneath the charcoal within the cylinder proximate a first end of the cylinder in a spaced apart relationship with the first end, a coupler defining a passageway extending through the wall of the cylinder proximate the metal baffle and on a side of the baffle opposite the first end and a blower connected to the coupler that blows air through the coupler into the cylinder.

Under another embodiment, the device includes a tube having an open top and bottom defined by sidewalls formed from a metal sheet joined at opposing ends, the tube having a number of apertures extending through the sidewalls adjacent the bottom, a metal baffle extending across the tube at a predetermined distance from the bottom the metal baffle having a plurality of apertures through the baffle sized to support charcoal briquettes without allowing the charcoal to fall through, a coupler defining a passageway through one of the sidewalls adjacent the baffle that allows air to be blown into the tube between the top and baffle in order to accelerate combustion of burning charcoal and a blower that directs low-pressure air through the coupler into the burning charcoal.

Under still another embodiment, the device includes a metal conduit having an open top and bottom defined by an enclosing sidewall, a metal baffle extending across the metal conduit between opposing sidewalls proximate the bottom and spaced from the bottom by a predetermined distance and a coupler defining a passageway through the sidewall proximate to and on a top side of the baffle, the coupler receives air flow from an external source.

### BRIEF DESCRIPTION OF THE DRAWINGS

FIG. 1 is a front perspective view of a chimney starter shown generally in accordance with an illustrated embodiment of the invention; and

FIG. 2 is a side view of the chimney starter of FIG. 1 shown in a context of use.

### DETAILED DESCRIPTION OF AN ILLUSTRATED EMBODIMENT

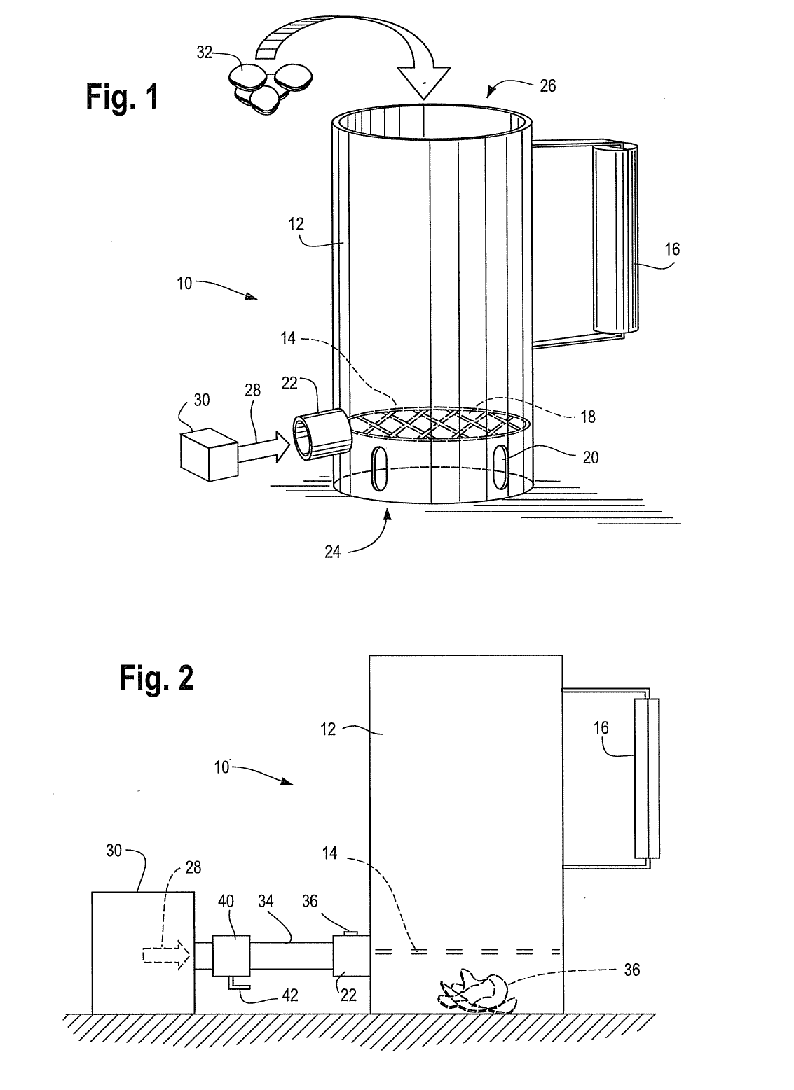

FIG. 1 depicts a chimney starter 10 shown generally in accordance with an illustrated embodiment of the invention. In general, the chimney starter 20 may include upright sidewalls 12, a baffle 14, a handle 16 and a coupler 22. The sidewalls 12 provide a vertical support and a receptacle for charcoal before and during the ignition phase of the charcoal fire. The sidewalls 12 may be provided in (and define) any shape extending upwards in the vertical direction. For example, the chimney may be provided in the form of a vertical rectangle, a square or a round shape.

In one embodiment as shown in FIG. 1, the sidewalls 12 define a hollow cylinder, tube or conduit with a height from bottom 24 to top 26 that is less than approximate 18 inches high and a diameter of less than 12 inches. A number of openings 20 are disposed around a circumference of the sidewalls 12 proximate the bottom 24 to admit combustion air.

In general, the sidewalls 12 may be fabricated from a rectangular sheet of metal (e.g., mild steel, stainless steel, etc.) joined at opposing ends. The opposing ends may be joined using any appropriate technology (e.g., screws, rivets, etc.).

The baffle 14 may be fabricated of an appropriate heat-resistant metal (e.g., mild steel, stainless steel, etc.) and extend between the opposing sidewalls 12. The baffle effectively provides a barrier or support for unburned charcoal 32 placed into the chimney 10 from the top 26. The baffle 14 may include any of a number of apertures 18 extending through the baffle 14. The apertures 18 may have a diameter (e.g., one-half inch) to easily allow ash from the burning charcoal to fall through while preventing unburned briquettes from falling through.

The baffle 14 may have a spaced apart relationship with the lower end 24 of the sidewalls 12. In one embodiment, the baffle 14 may be placed at a predetermined distance (e.g., two inches) from the lower marginal edge on the bottom 24 of the sidewalls 12.

The coupler 22 is disposed proximate the baffle 14 and defines a passageway for low-pressure air 28 from a low-pressure air supply 30 through the sidewalls 12 into the chimney 10. In a vertical direction, the coupler 22 is placed adjacent the baffle 14. In one preferred embodiment, the coupler 22 is place directly above the baffle 14 so that the low-pressure air impinges on charcoal resting on the baffle 14. In another preferred embodiment, the discharge end of the coupler 22 spans the baffle 14 and introduces low-pressure air that impinges on the edge of the baffle 14 so that some air impinges on the charcoal resting on the baffle 14 (directly adjacent the coupler 22) and some air passes below the baffle in order to provide a more even airflow to charcoal resting on the baffle 14 and that is located further from the coupler 22.

The coupler 22 may be provided under any appropriate format. The passageway through the coupler may be round, square or any other shape consistent with the cross-sectional configuration of the coupler. Under one embodiment, the coupler 22 may have a round passageway of approximately one to two inches diameter and may attach to the sidewalls 12 on a first end and have a receptacle on a second, opposing end. The first end may include a flange that is riveted to the sidewall 12. Alternatively, the first end may be threaded so that it can thread into an aperture in the sidewall 12. Alternatively, the threaded first end may be inserted through the aperture in the sidewall 12 from the outside and be secured to the sidewall by a nut that is screwed onto the threaded first end from inside the chimney 10.

FIG. 2 shows one example of the use of the chimney 10. In FIG. 2, the air source 30 is connected to the chimney 10 via a detachable connector tube 34 that is inserted into the receptacle of the coupler 22. The connector tube 34 may be fabricated of a heat resistant material or, alternatively, of plastic. A latch 36 may be provided to secure the tube 34 and source 30 to the coupler 22 of the chimney 10.

In this case, the source 30 may be any appropriate supply of low-pressure air 28. For example, a hair dryer or an electric inflator for a child's pool may be used as the source 30. Alternatively, an air hose from a conventional compressor may be used as a source of low-pressure air. In the case of the conventional compressor, an air valve may be placed in series with the compressor to regulate the air flow through the coupler 22.

During use, a person may place charcoal 32 into the chimney 10 through the upper end 26. Newspaper 36 may be placed in a chamber between the baffle 14 in the lower end of the chimney 10 and ignited. Once the newspaper is ignited, the air source 30 may be activated.

In order to further improve the rate of progression of the fire in the chimney 10, an air valve 40 may be provided in the connecting tube 34. In this case, a handle 42 of the valve 40 may be adjusted to a low airflow rate during the initial ignition of the newspaper via a match. Once the newspaper has been ignited, the air valve 40 may be opened to encourage the rapid spread of the flames through the newspaper and into the charcoal 32.

It should be noted in this regard, that the flow of low-pressure air through the connector tube 34 serves to cool the connector tube 34. This allows the connector tube 34 to be fabricated from a material that would otherwise be deformed by heat. Once the charcoal within the chimney 10 is ignited, the source 30 and tube 34 may be simply removed from the chimney 10 to avoid heat damage.

In another embodiment, the box 30 shown in FIG. 1 may be a natural gas or propane burner that is inserted into the coupler 22 to initially ignite the charcoal without the need for wadded-up newspaper. This has the ability to further accelerate ignition of the charcoal without any ash whatsoever as would normally be produced by burning newspaper.

In this case, the burner is ignited and inserted into the coupler 22 for some short period of time (e.g., 30 seconds) to initially ignite the charcoal 32. After the short period of time, the natural gas burner is replaced by the low-pressure air source 30 to complete the ignition process.

It has been found that the introduction of low-pressure air 28 through the coupler 22 significantly improves combustion efficiency and reduces the starting time of charcoal fires started in the chimney 10 over conventional chimney starters. In use, the starting time has been found to be reduced by at least one-half over the starting times of fires started using a conventional chimney starter.

The air introduced proximate the baffle 14 through the coupler 22 has been found to significantly reduce smoke and resulting air pollution. Smoke is substantially reduced or completely eliminated because the additional air introduced from the low-pressure source eliminates the incomplete combustion that would ordinarily occur due to a fire's progression through the wadded-up newspaper and, in turn progressing into cold charcoal.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A device comprising:
a rectangular strip of metal joined on opposing ends to form a wall of a hollow, open-ended cylinder that receives charcoal during ignition of the charcoal, the open-ended cylinder having a length of less than eighteen inches and a diameter less than twelve inches;
a metal baffle disposed beneath the charcoal within the cylinder proximate a first end of the cylinder in a spaced apart relationship with the first end;
a coupler defining a passageway extending through the wall of the cylinder proximate the metal baffle and on a side of the baffle opposite the first end; and
a blower connected to the coupler that blows air through the coupler into the cylinder.

2. The device as in claim 1 wherein the strip of metal further comprises stainless steel.

3. The device as in claim 1 further comprising a plurality of apertures extending through the wall dispersed around a periphery of the cylinder between the baffle and first end.

4. The device as in claim 1 further comprising a conduit that connects the coupler with the blower.

5. The device as in claim 4 wherein the coupler further comprises a receptacle that receives the conduit and a set screw that secures the conduit within the receptacle.

6. The device as in claim 1 wherein the blower further comprises an electric blower.

7. A device comprising:
a tube having an open top and bottom defined by sidewalls formed from a metal sheet joined at opposing ends, the tube having a number of apertures extending through the sidewalls adjacent the bottom;
a metal baffle extending across the tube at a predetermined distance from the bottom of the metal baffle having a plurality of apertures through the baffle sized to support charcoal briquettes without allowing the charcoal to fall through;
a coupler defining a passageway through one of the sidewalls adjacent the baffle that allows air to be blown into the tube between the top and baffle in order to accelerate combustion of burning charcoal; and
a blower that directs low-pressure air through the coupler into the burning charcoal.

8. The device as in claim 7 wherein the coupler further comprises a female receptacle that accepts a connector tube extending from the blower and that couples the low-pressure air from the blower into the passageway of the coupler.

9. The device as in claim 8 further comprising a latch that retains the connector tube within the receptacle.

10. A device comprising:
a metal conduit having an open top and bottom defined by an enclosing sidewall;
a metal baffle extending across the metal conduit between opposing sidewalls proximate the bottom and spaced from the bottom by a predetermined distance;
a coupler defining a passageway through the sidewall proximate to and on a top side of the baffle, the coupler receives air flow from an external source.

11. The device as in claim 10 further comprising a source of low-pressure air connected to the coupler.

12. The device as in claim 11 wherein the source of low-pressure air further comprises an inflator for a child's inflatable toy.

13. The device as in claim 11 further comprising a connector tube that connected between the source of low-pressure and the coupler.

14. The device as in claim 10 further comprising a gas burner connected to the coupler.
